(19) United States
(12) Patent Application Publication
(10) Pub. No.: US 2024/0201073 A1
(43) Pub. Date: Jun. 20, 2024

(54) Methods And Systems For Scatterometry Based Metrology Of Structures Fabricated On Transparent Substrates

(71) Applicant: KLA Corporation, Milpitas, CA (US)

(72) Inventors: Shankar Krishnan, Cupertino, CA (US); Kaichun Yang, Santa Clara, CA (US); Xi Chen, Fremont, CA (US)

(21) Appl. No.: 18/231,688

(22) Filed: Aug. 8, 2023

Related U.S. Application Data
(60) Provisional application No. 63/432,386, filed on Dec. 14, 2022.

(51) Int. Cl. G01N 21/21; G01N 21/956; G01N 21/958

(52) U.S. Cl. CPC G01N 21/211; G01N 21/956; G01N 21/958; G01N 2021/213

(57) ABSTRACT

Methods and systems for performing spectroscopic ellipsometry (SE) measurements of surface structures of optical elements fabricated on transparent substrates are presented herein. The SE measurement system is configured to detect light from the measured structures without contamination from light reflected from the backside surface of the transparent substrate. Surface structures of optical elements include film structures and grating structures fabricated on thin transparent substrates. The SE based measurement system is configured with a relatively large illumination Numerical Aperture (NA) and relatively high demagnification from the illumination source to the measurement spot on the optically transparent substrate. This configuration results in a relatively small measurement spot size and small depth of focus that minimizes the amount of light reflected from the backside of the optically transparent substrate. In addition, a relatively small collection aperture size further minimizes backside reflected light from reaching the detector.

### CROSS REFERENCE TO RELATED APPLICATION

The present application for patent claims priority under 35 U.S.C. § 119 from U.S. provisional patent application Ser. No. 63/432,386, entitled “Metalens metrology using Scatterometry CD (SCD),” filed Dec. 14, 2022, the subject matter of which is incorporated herein by reference in its entirety.

### TECHNICAL FIELD

The described embodiments relate to metrology systems and methods, and more particularly to methods and systems for improved measurement of advanced optical structures.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor optically transparent substrate. Additional examples of semiconductor fabrication processes include, but are not limited to, chemical-mechanical polishing, etch, deposition, and ion implantation. Multiple semiconductor devices may be fabricated on a single semiconductor optically transparent substrate and then separated into individual semiconductor devices.

Metrology processes are used at various steps during a semiconductor manufacturing process to detect defects on optically transparent substrates to promote higher yield. Optical metrology techniques offer the potential for high throughput without the risk of sample destruction. A number of optical metrology based techniques including scatterometry, ellipsometry, and reflectometry implementations and associated analysis algorithms are commonly used to characterize critical dimensions, film thicknesses, composition, overlay and other parameters of nanoscale structures.

Optical structures commonly referred to as meta-optics or metalens structures are rapidly emerging as an enabling lens technology for sensing and imaging applications in consumer electronics devices, autonomous vehicles, augmented reality displays, etc.

The focusing capability of conventional lenses, such as Fresnel lenses, is primarily based on accumulated phase differences as light propagates through different optical paths within the lens. Although Fresnel lens reduce the amount of material required to achieve a particular focusing performance compared to a conventional lens, Fresnel lenses are still bulky, expensive, require extremely precise polishing, etc.

Metalens optics include micro-patterned or nano-patterned surface relief structures that enable unique optical performance in a compact package. Metalens optical elements are very thin and planar shaped. The planar shape eliminates shape aberrations induced by conventional, non-planar optical structures, e.g., spherical aberrations, having comparable optical function. The relatively small scale of metalens optical elements enables a high degree of mechanical integration. This results in extremely compact optical systems having complex and precise optical functionality.

The flat, ultra-thin characteristics of metalens optical elements find applications in a wide range of industrial equipment, such as electron-beam lithographic systems and other imaging systems. In some examples, surface structures of metalens elements are integrated on waveguide devices. In some examples, multiple color hologram generation and wavelength multiplexing are integrated on a single chip using metalens structures.

The surface structures of metalens optics control the amplitude, phase, polarization state, etc., of propagating light. In some examples, the surface structures of a metalens optical element include nano-antenna structures fabricated at sub-wavelength dimensions. In some examples, nano-antenna structures are designed to match specific wavelengths of light. In some examples, nano-antenna structures are designed in a hybrid mode that reducing chromatic aberrations.

Nano-antennas structures are designed to control the light profile at a micrometer or nanometer dimensional scale. The ability to control light at this scale may be applied in various industrial applications such as optical wireless communication system, sub-wavelength imaging systems, light trapping in solar cells, etc.

In some examples, the radiation pattern of nano-antenna structures is dynamically controlled. The ability to dynamically tune the optical characteristics of a metalens based optical device integrated with a programmable integrated circuit enables performance enhancements in many application areas, such as dynamic hologram generation, LIDAR, imaging systems, and optical wireless communications.

Many surface structures of metalens optical elements are readily fabricated using manufacturing processes developed for the manufacture of semiconductor devices, e.g., lithography, etch, deposition, etc. In some examples, surface structures, e.g., nano-antennas, of metalens optical elements are fabricated at sub-wavelength dimensions by well-developed semiconductor process technology, such as CMOS processing techniques and equipment. The ability to leverage semiconductor manufacturing technology in the production of metalens based optical structures enables low cost production of metalens based optical elements on a massive scale.

Metalens based optical elements are typically fabricated on very thin, optically transparent substrates, and typically include structures having a relatively large spatial periodicity compared to semiconductor memory or logic structures. These characteristics create challenges for film and CD measurements. The ability to measure the critical dimensions that define the shape of metalens surface structures is critical to achieve desired optical performance levels and device yield.

Existing metrology tools manufactured by KLA Corporation include the SpectraShape™ SS10k, SS11K, and S12k tools focused on critical dimension and shape metrology, and SpectraFilm™ F1-F20 tools focused on film metrology. These tools include a relatively large collection NA in the AOI direction, which allows light back reflected from the bottom surface of a metalens substrate to contaminate the measurement signals.

In summary, the structural features of metalens optical elements fabricated on transparent substrates impose difficult requirements on optical metrology systems. Optical metrology systems must meet high precision and accuracy requirements for increasingly complex structures at high throughput to remain cost effective. In this context, collection NA and spectrometer slit size have emerged as critical, performance limiting issues in the design of optical metrology systems suitable for advanced optical structures. Thus, improved metrology systems and methods to overcome these limitations are desired.

### SUMMARY

Methods and systems for performing spectroscopic ellipsometry (SE) measurements of surface structures of optical elements fabricated on transparent substrates are presented herein. The SE measurement system is configured to detect light from the measured structures without contamination from light reflected from the backside surface of the transparent substrate. Surface structures of metalens based optical elements include film structures and grating structures fabricated on transparent substrates for various applications including, but not limited to optical waveguides, augmented reality and virtual reality display devices, imaging subsystems, etc.

In one aspect, the surface structures of metalens based optical elements are fabricated on optically transparent substrates, e.g., glass substrates, sapphire substrates, etc. In addition, the optically transparent substrates are very thin, e.g., thickness of less than 1 millimeter. In some embodiments, the thickness of an optically transparent substrate is less than 500 micrometers. In some embodiments, the thickness of an optically transparent substrate is less than 250 micrometers.

In another aspect, an SE based measurement system is configured with a relatively large illumination Numerical Aperture (NA) and relatively high demagnification from the illumination source to the measurement spot on the optically transparent substrate. This configuration results in a relatively small measurement spot size and small depth of focus, and minimizes the amount of light reflected from the backside of the optically transparent substrate into an optical path of the collection optics. In some embodiments, the illumination optics subsystem has a NA of at least 0.15 and an image demagnification from an illumination field stop of the illumination optics subsystem to the measurement spot of at least 10.

In a further aspect, the size of an aperture of the collection mask is relatively small, e.g., less than one millimeter, to further minimize the propagation of light reflected from the backside of the optically transparent substrate to the detector. In some embodiments, the collection optics subsystem includes a collection mask disposed at or near an image plane of the collection optics subsystem. The collection mask includes an aperture having a dimension of less than one millimeter in a direction aligned with a direction of changing angle of incidence. In this manner, a reflection of the SE measurement beam from the backside of the optically transparent substrate is effectively blocked by the collection mask.

In a further aspect, the substrate handling chuck employed to fixture the optically transparent substrate is coated with a black colored material to minimize scatter form the chuck surface

In some embodiments, a SE based metrology system is configured to estimate the reflectivity of a metalens based structure fabricated on an optically transparent substrate. In one example, the reflectivity of a metalens based structure fabricated on an optically transparent substrate is estimated based on an average measured intensity measured at the detector of the SE based metrology system.

In some embodiments, a metalens structure includes multiple grating orientation vectors. In a further aspect, metalens structures are measured at each grating vector orientation sequentially at the same measurement site. In this manner, measurement throughput is minimized when multiple grating clusters each located at different measurement sites are to be measured. In some embodiments, SE measurements are performed sequentially at different azimuth angles. Each azimuth angle is aligned with a different grating vector orientation associated with the metalens structure under measurement. Estimated values of parameters of interest characterizing the metalens structure along each grating vector orientation are determined based on the detected signals associated with measurements at the azimuth angle corresponding to the each grating vector orientation.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 depicts an exemplary metrology system 100 for performing spectroscopic measurements of one or more structures disposed on an optically transparent substrate as described herein.

FIG. 2 depicts a portion of the collection optical elements and collection optical path of metrology system 100 in greater detail.

FIG. 3 depicts an image of a metalens based structure including amorphous silicon pillars fabricated on a glass substrate.

FIG. 4 depicts a magnified image of the metalens based structure depicted in FIG. 3.

FIG. 5 depicts a further magnified image of the metalens structure depicted in FIG. 3.

FIG. 6 is a diagram illustrative of a top view of a geometric model of a metalens structure including amorphous silicon pillars fabricated on a glass substrate in a three dimensional pattern.

FIG. 7 is a diagram illustrative of a side view of the geometric model of the metalens structure depicted in FIG. 6.

FIG. 8 depicts an embodiment 180 of a combined illumination source.

FIG. 9A depicts another embodiment 200 of a combined illumination source.

FIG. 9B depicts another embodiment 220 of a combined illumination source.

FIG. 9C depicts another embodiment 240 of a combined illumination source.

FIG. 10 depicts a plot illustrative of the specific detectivity of various detector technologies operating at specified temperatures.

FIG. 11 depicts an illustration of a multi-zone infrared detector 270.

FIG. 12 illustrates typical photosensitivity curves of four available Indium Gallium Arsenide (InGaAs) sensors.

FIG. 13 illustrates a method 300 of performing spectroscopic measurements of one or more structures disposed on an optically transparent substrate as described herein.

### DETAILED DESCRIPTION

Reference will now be made in detail to background examples and some embodiments of the invention, examples of which are illustrated in the accompanying drawings.

Methods and systems for performing spectroscopic ellipsometry (SE) measurements of surface structures of optical elements fabricated on transparent substrates are presented herein. The SE measurement system is configured to detect light from the measured structures without contamination from light reflected from the backside surface of the transparent substrate. Surface structures of metalens based optical elements include film structures and grating structures fabricated on transparent substrates for various applications including, but not limited to optical waveguides, augmented reality and virtual reality display devices, imaging subsystems, etc.

An SE based measurement system estimates values of one or more parameters of interest characterizing surface structures of metalens based optical elements including, but not limited to pillar structures, post structures, etc. The parameters of interest include, but are not limited to, parameters characterizing geometric or material characteristics of metalens surface structures, such as critical dimensions, height, sidewall angle, film thickness, height, reflectivity, etc.

In one aspect, the surface structures of metalens based optical elements are fabricated on optically transparent substrates, e.g., glass substrates, sapphire substrates, etc. In addition, the optically transparent substrates are very thin, e.g., thickness of less than 1 millimeter. In some embodiments, the thickness of an optically transparent substrate is less than 500 micrometers. In some embodiments, the thickness of an optically transparent substrate is less than 250 micrometers.

In another aspect, an SE based measurement system is configured with a relatively large illumination Numerical Aperture (NA) and relatively high demagnification from the illumination source to the measurement spot on the optically transparent substrate. This configuration results in a relatively small measurement spot size and small depth of focus, and minimizes the amount of light reflected from the backside of the optically transparent substrate into an optical path of the collection optics. In some embodiments, the illumination optics subsystem has a NA of at least 0.15 and an image demagnification from an illumination field stop of the illumination optics subsystem to the measurement spot of at least 10.

In a further aspect, the size of an aperture of the collection mask is relatively small, e.g., less than one millimeter, to further minimize the propagation of light reflected from the backside of the optically transparent substrate to the detector. In some embodiments, the collection optics subsystem includes a collection mask disposed at or near an image plane of the collection optics subsystem. The collection mask includes an aperture having a dimension of less than one millimeter in a direction aligned with a direction of changing angle of incidence. In this manner, a reflection of the SE measurement beam from the backside of the optically transparent substrate is effectively blocked by the collection mask.

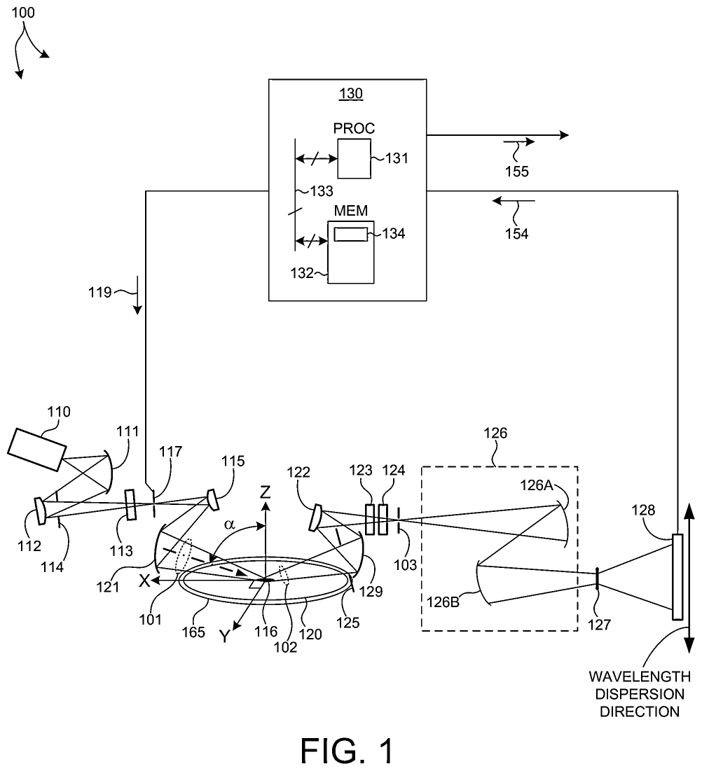

FIG. 1 depicts an exemplary, metrology system 100 for performing broadband spectroscopic measurements of structures fabricated on optically transparent substrates. In some examples, the one or more structures include surface structures of a metalens optical element. In some of these examples, the surface structures are fabricated from an optically opaque material such as an oxide material. As depicted in FIG. 1, metrology system 100 is configured as an oblique incidence, broadband spectroscopic ellipsometer. However, in general, metrology system 100 may also include additional spectroscopic ellipsometers, a spectroscopic reflectometer, angle-resolved reflectometer, scatterometer, or any combination thereof.

Metrology system 100 includes an illumination source 110 that generates a beam of illumination light 101 incident on a optically transparent substrate 120. Illumination source 110 includes one or more illumination sources that emit illumination light including wavelengths in a range from 120 nanometers to 2,500 nanometers. In some embodiments, illumination source 110 is a combined illumination source that emits illumination light in the ultraviolet, visible, and infrared spectra, including ultraviolet wavelengths down to 120 nanometers and infrared wavelengths greater than two micrometers, e.g., illumination wavelengths ranging from 120 nanometers to 2,500 nanometers. In some other embodiments, illumination source 110 is a combined illumination source that emits illumination light including wavelengths in a range from 120 nanometers to 7,000 nanometers.

In a preferred embodiment, combined illumination source 110 includes a supercontinuum laser source and a laser sustained plasma light source. The supercontinuum laser source provides illumination at wavelengths greater than two micrometers, and in some embodiments, up to 5 micrometers, or more. The laser sustained plasma (LSP) light source (a.k.a., laser driven plasma source) produces photons across the entire wavelength range from 120 nanometers to 2500 nanometers and beyond. The pump laser of the LSP light source may be continuous wave or pulsed. In some embodiments, combined illumination source 110 includes a supercontinuum laser source and an arc lamp, such as a Xenon arc lamp. However, a laser-driven plasma source produces significantly more photons than a Xenon lamp across the entire wavelength range from 120 nanometers to 2500 nanometers, and is therefore preferred.

In general, combined illumination source 110 includes a combination of a plurality of broadband or discrete wavelength light sources. The light generated by combined illumination source 110 includes a continuous spectrum or parts of a continuous spectrum, from ultraviolet to infrared (e.g., vacuum ultraviolet to long infrared). In general, combined illumination light source 110 may include a supercontinuum laser source, an infrared helium-neon laser source, a silicon carbide globar light source, a tungsten halogen light source, one or more infrared LEDs, one or more infrared lasers or any other suitable infrared light source generating wavelengths greater than two micrometers, and an arc lamp (e.g., a Xenon arc lamp), a deuterium lamp, a LSP light source, or any other suitable light source generating wavelengths less than two micrometers including visible and ultraviolet wavelengths.

In general, combined illumination source 110 includes multiple illumination sources optically coupled in any suitable manner. In some embodiments, light emitted by a supercontinuum laser source is directly coupled through the plasma generated by the ultraviolet/visible light source.

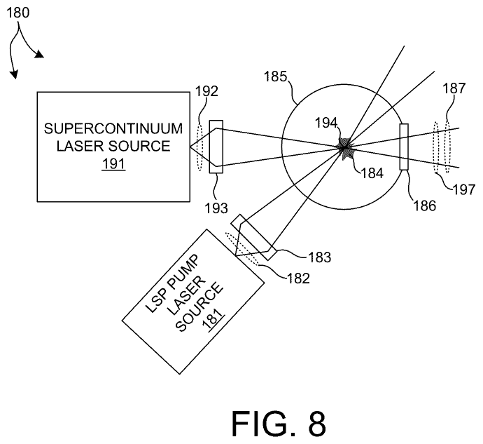

FIG. 8 depicts an embodiment 180 of a combined illumination source 110. As depicted in FIG. 8, a LSP pump laser source 181 generates pump light 182 that is focused by focusing optics 183 to sustain a plasma 184 contained by bulb 185. Plasma 184 generates broadband spectrum light over a wavelength range of ultra-violet to short infrared. Bulb 185 includes an exit port 186. LSP output light 187 is the portion of light from plasma 184 that passes through exit port 186 and is directed towards the illumination optics subsystem as described with reference to FIG. 1. In addition, supercontinuum laser source 191 generates infrared light 192 that is focused by focusing optics 193 to a focus 194 at or near plasma 184. Supercontinuum output light 197 is the portion of light from the focus 194 that passes through exit port 186 and is directed towards the illumination subsystem as described with reference to FIG. 1. In one example, the LSP output light 187 and supercontinuum output light 197 are co-located. In this manner, infrared light 197 from supercontinuum source 191 is effectively combined with ultraviolet/visible light 187 from LSP laser source 181. In one example, LSP output light 187 and supercontinuum output light 197 have the same or similar numerical aperture. In another example, LSP output light 187 and supercontinuum output light 197 have different numerical aperture. In some examples, bulb 185 is constructed from Calcium Fluoride or Magnesium Fluoride to transmit wavelengths above 2.5 micrometers generated by supercontinuum laser source 191. In some other examples, bulb 185 includes one or more exit ports 186 fabricated from Calcium Fluoride or Magnesium Fluoride to transmit wavelengths above 2.5 micrometers generated by supercontinuum laser source 191. A conventional bulb constructed from fused silica does not transmit significant light above 2.5 micrometers, and is thus unsuitable for combining light generated by the supercontinuum laser source 191 in the manner described herein. In some embodiments, the LSP pump laser source 181 is a continuous wave laser. In some other embodiments, the LSP pump laser source 181 is a pulsed laser.

As depicted in FIG. 1, metrology system 100 includes an illumination optics subsystem configured to direct illumination light 101 to one or more structures formed on the optically transparent substrate 120. The illumination subsystem may include any type and arrangement of optical filter(s), polarizing component, field stop, pupil stop, etc., known in the art of spectroscopic metrology. As depicted in FIG. 1, the illumination subsystem includes light source 110, beam shaping optics 111, 112, 115, and 121, polarizing component 113, and pupil stop 114. As depicted, in FIG. 1, the beam of illumination light 101 is reflected from beam shaping optics 111, 112, 115, and 121 and passes through illumination pupil stop 114, polarizing component 113, and illumination field stop 117 as the beam propagates from the illumination source 110 to optically transparent substrate 120. Beam 101 illuminates a portion of optically transparent substrate 120 over a measurement spot 116. As depicted in FIG. 1, beam shaping optics 111, 112, 115, and 121, include one or more optical elements having reflective focusing power.

In the embodiment depicted in FIG. 1, pupil stop 114 controls the numerical aperture (NA) of the illumination subsystem and may include any suitable commercially available aperture stop. In one aspect, the illumination subsystem is configured to direct illumination light 101 with an illumination Numerical Aperture (NA) of at least 0.15 to optically transparent substrate 120. In addition, beam shaping optics 115 and 121 control the image demagnification from illumination field stop 117 to measurement spot 116, i.e., project an image of the illumination field stop 117 to measurement spot 116 that is smaller by a demagnification factor. In some embodiments, beam shaping optics 115 and 121 demagnify the image of the illumination field stop 117 by a demagnification factor of at least 10, i.e., 10× smaller. Note that the dimensions of measurement spot 116 across optically transparent substrate 120 are not smaller than the dimensions of the illumination field stop 117 by the demagnification factor because substrate 120 is not oriented perpendicular to the illumination beam path at the point of incidence of the illumination beam 101 onto substrate 120. In some embodiments, illumination light 101 is incident at optically transparent substrate 120 at an angle of incidence, a, at or near 65 degrees from normal incidence. In some embodiments, the dimension of the measurement spot 116 along a direction of maximum extent is less than 50 micrometers.

In addition, the illumination optics subsystem may include filters, masks, apodizers, etc. For example, the illumination subsystem may include one or more optical filters (not shown). The optical filters are employed to control light level, spectral output, or both, from the illumination subsystem. In some examples, one or more multi-zone filters are employed as optical filters.

In some examples, the beam size of the amount of illumination light 101 projected onto the surface of optically transparent substrate 120 is smaller than a size of a measurement target that is measured on the surface of the specimen. Exemplary beam shaping techniques are described in detail in U.S. Patent Application Publication No. 2013/0114085 by Wang et al., the contents of which are incorporated herein by reference in their entirety.

In some examples, noise and polarization optimization are performed to improve the performance of illumination source 110. In some examples, depolarization is achieved by use of multimode fibers, a Hanle depolarizer, or an integration sphere. In some examples, the illumination source etendue is optimized by use of light guides, fibers, and other optical elements (e.g., lenses, curved mirrors, apodizers, etc.). In some examples, source coherence or coherence effects are mitigated by coherence breaking techniques, or are otherwise accounted for by modeling and simulation.

Polarizing component 113 generates the desired polarization state exiting the illumination subsystem. In some embodiments, the polarizing component includes a polarizer, a compensator, or both, and may include any suitable commercially available polarizing component. The polarizer, compensator, or both, can be fixed, rotatable to different fixed positions, or continuously rotatable. Although the illumination subsystem depicted in FIG. 1 includes one polarizing component, the illumination subsystem may include more than one polarizing component. In some embodiments, a polarizer of polarizing component 113 is a Magnesium Fluoride Rochon polarizer. In some embodiments, a compensator of polarizing component 113 includes a quartz waveplate, a Magnesium Fluoride waveplate, a Calcium Fluoride K-prism, a Calcium Fluoride double Fresnel rhomb, or any combination thereof. In some embodiments, a compensator of polarizing component 113 includes one or more waveplates. In some of these embodiments, a first waveplate includes a desired retardation over a first wavelength range and a second waveplate includes a desired retardation over a second wavelength range, etc.

Metrology system 100 also includes a collection optics subsystem configured to collect light generated by the interaction between the one or more structures and the incident illumination beam 101 and focus the collected light at or near a dispersive element, e.g., a spectrometer slit, of a spectrometer. The collection optics subsystem may include any type and arrangement of optical filter(s), polarizing component, collection field stop, collection pupil stop, etc., known in the art of spectroscopic metrology. In general, a collection optics subsystem includes a field stop, a pupil mask, and one or more optical elements having focusing power.

As depicted in FIG. 1, a beam of collected light 102 is collected from measurement spot 116 by a collection optics subsystem. As the beam of collection light 102 propagates from optically transparent substrate 120 to dispersive element 127 of the spectrometer, collected light 102 is reflected from beam shaping optics 129 and 122 and elements of reflective collection relay optics 126, and passes through collection pupil stop 125, compensator 123, analyzer 124, and collection field stop 103 of the collection optics subsystem.

As depicted in FIG. 1, the collection optics subsystem includes a polarizing component that analyzes the polarization state of the collected light. In some embodiments, the polarizing component includes an analyzer, a compensator, or both, and may include any suitable commercially available polarizing component. The analyzer, compensator, or both, can be fixed, rotatable to different fixed positions, or continuously rotatable. The collection subsystem depicted in FIG. 1 includes a compensator 123 and an analyzer 124. In general, a collection optics subsystem may include any number of polarizing elements.

In some embodiments, compensator 123 includes a quartz waveplate, a Magnesium Fluoride waveplate, a Calcium Fluoride K-prism, a Calcium Fluoride double Fresnel rhomb, or any combination thereof. In some embodiments, compensator 123 includes one or more waveplates. In some of these embodiments, a first waveplate includes a desired retardation over a first wavelength range and a second waveplate includes a desired retardation over a second wavelength range, etc. In some embodiments, analyzer 124 is a Magnesium Fluoride Rochon analyzer.

As depicted in FIG. 1, the collection optics subsystem includes a collection pupil stop 125 disposed near a pupil of the collection optics subsystem. Collection pupil stop 125 includes one or more apertures, i.e., openings, configured to transmit collected light at one or more angles of incidence (AOIs) from optically transparent substrate 120, and block light from other AOIs. In some embodiments, collection pupil stop 125 includes three apertures that transmit collected light from three different ranges of AOIs from optically transparent substrate 120. Furthermore, collection pupil stop 125 is configured to transmit collected light at each of the one or more ranges of angles of incidence with a NA greater than 0.15 in the AOI direction. In some embodiments, collection mask 125 transmits collected light at each of the ranges of one or more angles of incidence with a NA in a range from 0.15 to 0.19 in the AOI direction. In some embodiments, metrology system 100 is configured with a collection NA that is the same or nearly the same as the illumination NA.

In the embodiment depicted in FIG. 1, collection field stop 103 controls the field of view of the collection optics subsystem. In some other embodiments, a spectrometer slit is employed to define the field of view of the collection optics subsystem. In a further aspect, beam shaping optics 122 and 129 control the image magnification from measurement spot 116 to detector 128, i.e., project an image of the measurement spot 116 to detector 128 that is larger by a magnification factor. In some embodiments, beam shaping optics 122 and 129 magnify the image of the measurement spot 116 by a magnification factor of at least 10, i.e., 10× larger. In this manner, beam shaping optics 122 and 129 provide a field magnification of at least 10.

In the embodiment depicted in FIG. 1, the size of an aperture of the collection field stop 103 in a direction aligned with the direction of changing angle of incidence is less than one millimeter. The relatively small aperture size of collection field stop 103 minimizes the propagation of light reflected from the backside of the optically transparent substrate to the detector.

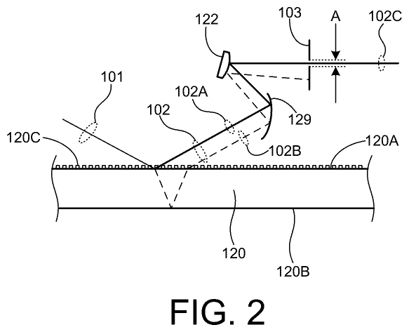

As depicted in FIG. 2, illumination beam 101 is incident on the top surface 120A of optically transparent substrate 120. A portion of illumination beam 101 interacts with structures 120C on the top surface 120A of optically transparent substrate 120 and effectively reflects from the top surface 120A, forming a portion 102A of collected light 102. However, another portion of illumination beam 101 refracts at the top surface 120A and propagates to the bottom surface 120B of optically transparent substrate 120, reflects from the bottom surface 120B, propagates back to the top surface 120A, and refracts at the top surface 120A. The light reflected from the bottom surface 120B forms a portion 102B of collected light 102. Both portions 102A and 102B of collected light 102 propagate through beam shaping elements 129 and 122 and are incident on collection field stop 103. As depicted in FIG. 2, collection field stop 103 is located at or near an image plane of the collection optics subsystem. The collection field stop 103 includes an aperture having a dimension, A, of less than one millimeter in a direction aligned with a direction of changing angle of incidence. In this manner, the portion of collected light 102B reflected from the bottom surface 120B of optically transparent substrate 120 is effectively blocked by the collection field stop 103, while a portion 102C of collected light 102A reflected from the top surface 120A of optically transparent substrate 120 is transmitted toward detector 128. In one example, the portion of collected light 102B reflected from the bottom surface 120B of optically transparent substrate 120 is offset from the aperture of collection field stop 103 by approximately 5 millimeters. Thus, the undesired light is effectively blocked by the collection field stop 103 having an aperture of approximately 1 millimeter.

In some embodiments, a spectrometer subsystem includes the collection field stop 103, dispersive element 127, and one or more optics having reflective focusing power (not shown). The collection field stop 103 receives light from the collection optics subsystem including relay optics 126, and transmits a portion of the collected light to dispersive element 127. Dispersive element 127 disperses the light into discrete wavelengths on the active surface of detector 128.

Dispersive element 127 is typically located at or near a pupil plane of the collection optics subsystem. Relay optics 126 receives light from collection pupil stop 125 and images the light from collection pupil stop 125 to a pupil plane at or near dispersive element 127. In this manner, collection relay optics 126 functions as a pupil relay and images the collection pupil stop 125 on dispersive element 127.

In some embodiments, the optical elements of collection relay optics 126 are reflective optical elements. Reflective collection relay optics enable shorter wavelength collection light, e.g., wavelengths less than 190 nanometers. In some embodiments, reflective collection relay optics enable collection light having wavelengths in a range from 140 nanometers to 2,500 nanometers. As depicted in FIG. 1, reflective collection relay optics 126 includes reflective optical elements 126A and 126B. However, in general, reflective collection relay optics 126 may include any number of reflective optical elements. In some embodiments of metrology system 100, collection relay optics 126 are not included.

Dispersive element 127 is typically a diffraction grating or a dispersive prism. In some embodiments, dispersive element 127 includes one or more segments and each segment receives light from one or more corresponding apertures of collection pupil stop 125. In this manner, light dispersed by dispersive element 127 includes light corresponding to one or more discrete ranges of angles of incidence at the optically transparent substrate. In some embodiments, dispersive element 127 is a planar diffraction grating. In some of these embodiments, the planar diffraction grating is segmented to split the pupil into segments each corresponding to a different set of discrete ranges of angles of incidence at the optically transparent substrate. Further details regarding pupil splitting are described in U.S. Pat. No. 10,690,602 to KLA-Tencor Corporation, the content of which is incorporated herein by reference in its entirety.

As depicted in FIG. 1, detector 128 receives light collected from optically transparent substrate 120 at one or more angles of incidence, multiple wavelengths, e.g., 140 nanometers to 2,500 nanometers, and one or more polarization states. In the embodiment depicted in FIG. 1, the collection optics subsystem directs light to detector 128 and the detector 128 generates output signals 154 responsive to light collected from the one or more structures illuminated by the illumination subsystem. The dispersive element 127 linearly disperses diffracted light according to wavelength along one dimension of detector 128 (i.e., the wavelength dispersion direction noted in FIG. 1). Dispersive element 127 causes a spatial separation among different wavelengths of light projected onto the surface of detector 128. In this manner, light collected from measurement spot 116 having a particular wavelength is projected onto detector 128 at a spatial location that is different from light collected from measurement spot 116 having another, different wavelength.

Metrology system 100 also includes computing system 130 configured to receive detected signals 154 and determines an estimated value of a parameter of interest 155 of the measured structure(s) based on the detected signals.

In some embodiments, the methods and systems for spectroscopic metrology described herein are applied to the measurement of metalens based structures, in particular critical dimension metrology of metalens based structures. Metalens structures are periodic in nature, and thus are amenable to measurement using scatterometry techniques.

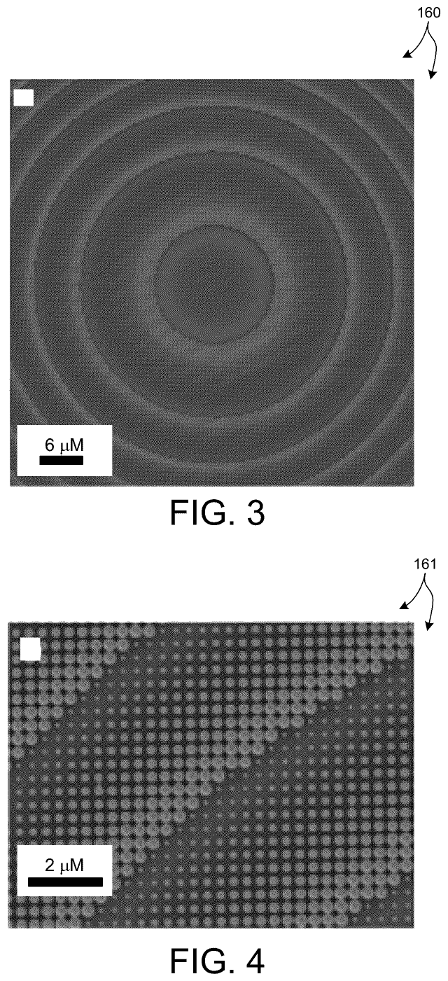

FIG. 3 is an image 160 depicting a metalens based structure including amorphous silicon pillars fabricated on a glass substrate.

FIG. 4 is a magnified image 161 depicting the metalens based structure depicted in FIG. 3.

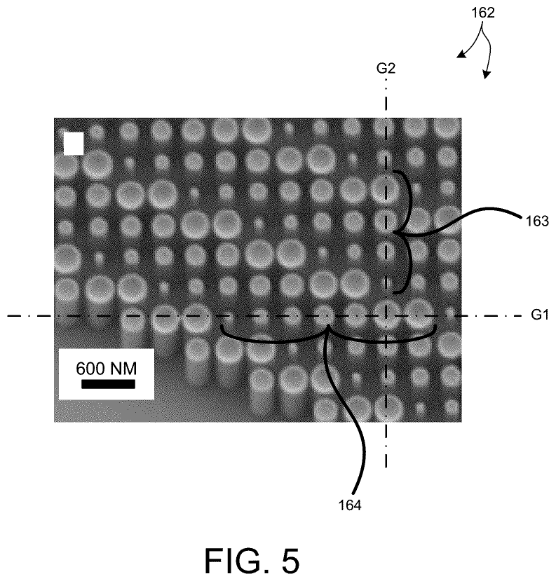

FIG. 5 is a further magnified image 162 depicting the metalens structure depicted in FIG. 3.

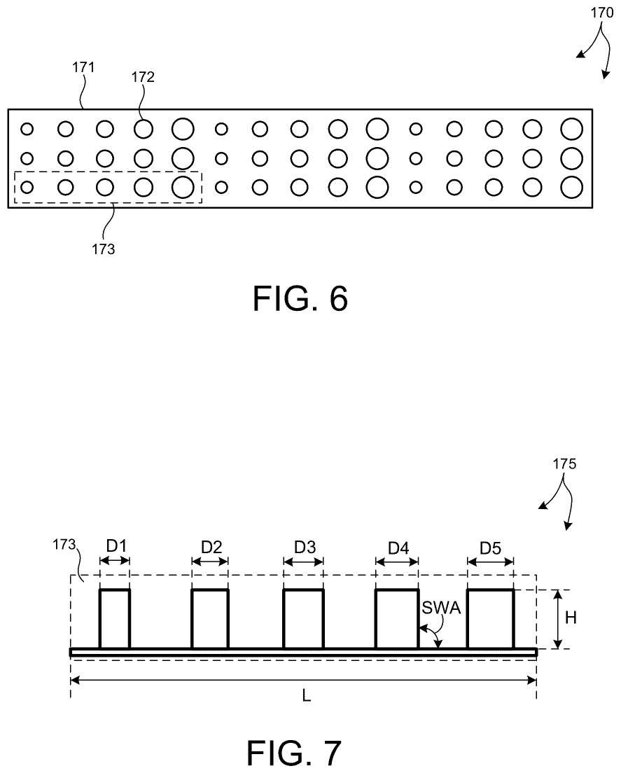

FIG. 6 is a diagram 170 illustrative of a top view of a geometric model of a metalens structure including amorphous silicon pillars, e.g., pillar 172, fabricated on a glass substrate in a three dimensional pattern. As depicted in FIG. 6, a repeated array of unit cells including different sized pillar structures are disposed on a glass substrate 171. As depicted in FIG. 6, each unit cell, e.g., unit cell 173, includes five pillar structures each having a different diameter.

FIG. 7 is a diagram 175 illustrative of a side view of the geometric model of the metalens structure depicted in FIG. 6. As depicted in FIG. 7, each pillar of unit cell 173 is spaced equidistant and has a different diameter. In one example, D1 is 170 nanometers, D2 is 190 nanometers, D3 is 210 nanometers, D4 is 230 nanometers, and D5 is 250 nanometers, height, H, is 250 nanometers, sidewall angle, SWA, is 90 degrees, and the length of the unit cell is 2 micrometers. A simulation of a measurement of the parameters characterizing geometric model 170 using metrology system 100 exhibited measurements with CD precision down to approximately 0.02 nanometers with very low parameter correlation.

In a further aspect, the substrate handling chuck employed to fixture the optically transparent substrate is coated with a black colored material to minimize scatter form the chuck surface. In the embodiment depicted in FIG. 1, substrate handling chuck 165 is coated, e.g., anodized, powder coated, etc., with a material that is black in color to avoid scatter from the chuck surface that might reach detector 128.

In another further aspect, a spectroscopic ellipsometer, e.g., SE based metrology system 100 depicted in FIG. 1, is configured to estimate the reflectivity of a metalens based structure fabricated on an optically transparent substrate. In one example, the reflectivity of a metalens based structure fabricated on an optically transparent substrate is estimated based on an average measured intensity measured at detector 128 of SE based metrology system 100.

As depicted in FIG. 5, the depicted metalens structure includes two different grating orientation vectors, G1 and G2. A unit cell 164 includes eight different sized pillar structures aligned with orientation vector G1 and unit cell 163 includes four different sized pillar structures aligned with orientation vector G2. In general, metalens structures fabricated on optically transparent substrates are arranged with spatial periodicity along multiple grating vector orientations.

In a further aspect, metalens structures are measured at each grating vector orientation sequentially at the same measurement site. In this manner, measurement throughput is minimized when multiple grating clusters each located at different measurement sites are to be measured.

In some embodiments, SE measurements are performed sequentially at different azimuth angles. Each azimuth angle is aligned with a different grating vector orientation associated with the metalens structure under measurement. Estimated values of parameters of interest characterizing the metalens structure along each grating vector orientation are determined based on the detected signals associated with measurements at the azimuth angle corresponding to the each grating vector orientation. In these embodiments, the azimuth angles associated with each grating vector orientation are known apriori based on design data associated with the metalens structure. Similarly, the geometric model characterizing each grating vector orientation is constructed based on the design data. In this manner, the measurement model employed to estimate values of the parameter of interest characterizing the metalens structure under measurement is specific to the geometric features associated with each different grating vector orientation.

As depicted in FIG. 1, metrology system 100 includes a spectral ellipsometer measurement system. However, in general, metrology system 100 may include any number of additional measurement systems, e.g., angle resolved reflectometer system, spectroscopic reflectometer system, etc. By way of non-limiting example, metrology system 100 may be configured to include a spectroscopic ellipsometer (including Mueller matrix ellipsometry), a spectroscopic reflectometer, a spectroscopic scatterometer, an overlay scatterometer, an angular resolved beam profile reflectometer, a polarization resolved beam profile reflectometer, a beam profile reflectometer, a beam profile ellipsometer, any single or multiple wavelength ellipsometer, or any combination thereof.

In general, a collection optics subsystem may direct light to more than one detector. In these embodiments, two or more detectors are each configured to detect collected light over different wavelength ranges, simultaneously.

In one example, one detector is a charge coupled device (CCD) sensitive to ultraviolet and visible light (e.g., light having wavelengths between 190 nanometers and 860 nanometers), and another detector is a photo detector array (PDA) sensitive to infrared light (e.g., light having wavelengths between 950 nanometers and 5000 nanometers). However, in general, other two dimensional detector technologies may be contemplated (e.g., a position sensitive detector (PSD), an infrared detector, a photovoltaic detector, etc.). Each detector converts the incident light into electrical signals indicative of the spectral intensity of the incident light. In some embodiments, the detection subsystem is arranged such that the collected light propagates to all detectors of metrology system 100, simultaneously. By simultaneously collecting UV and IR spectra, measurement times are reduced and all spectra are measured with the same alignment conditions. This allows wavelength errors to be corrected more easily because a common correction can be applied to all spectral data sets.

In general, dispersive element 127 may be configured to subdivide the incident light into different wavelength bands, propagate the different wavelength bands in different directions, and disperse the light of one of the wavelength bands onto one or more detectors in any suitable manner. In one example, dispersive element 127 is configured as a transmissive grating. In some other examples, dispersive element 127 includes a beamsplitting element to subdivide the beam into different wavelength bands and a reflective or transmissive grating structure to disperse one of the wavelength bands onto a detector.

In some embodiments, dispersive element 127 is a reflective grating configured to diffract a subset of wavelengths of the incident light into the +/−1 diffraction order toward one detector and diffract a different subset of wavelengths of the incident light into the zero diffraction order toward another detector.

By measuring a target with infrared, visible, and ultraviolet light in a single system, precise characterization of complex three dimensional structures is enabled. In general, relatively long wavelengths penetrate deep into a structure and provide suppression of high diffraction orders when measuring structures with relatively large pitch. Relatively short wavelengths provide precise dimensional information about structures such as relatively small CD and roughness features. In some examples, longer wavelengths enable measurement of dimensional characteristics of targets with relatively rough surfaces or interfaces due to lower sensitivity of longer wavelengths to roughness. In general, measuring a target with infrared, visible, and ultraviolet light in a single system improves sensitivity to some measurement parameters and reduces correlations among parameters.

In some embodiments, a spectroscopic measurement system includes a combined illumination source including a first illumination source that generates ultraviolet, visible, and near infrared wavelengths (e.g., wavelengths less than two micrometers) and a second illumination source that generates mid infrared and long infrared wavelengths (e.g., wavelengths of two micrometers and greater). In some examples, the combined illumination source generates illumination light having wavelengths down to 140 nanometers. In some examples, the combined illumination source generates illumination light having wavelengths up to and including 4.2 micrometers. In some examples, the combined illumination source generates illumination light having wavelengths up to and including 5 micrometers. In some examples, the combined illumination source generates illumination light having wavelengths that exceed 5 micrometers. Furthermore, the spectroscopic measurement system includes one or more measurement channels spanning the range of illumination wavelengths employed to perform measurements of semiconductor structures. The one or more measurement channels are operable in parallel (i.e., simultaneous measurement of the sample throughout the wavelength range) or in sequence (i.e., sequential measurement of the sample throughout the wavelength range).

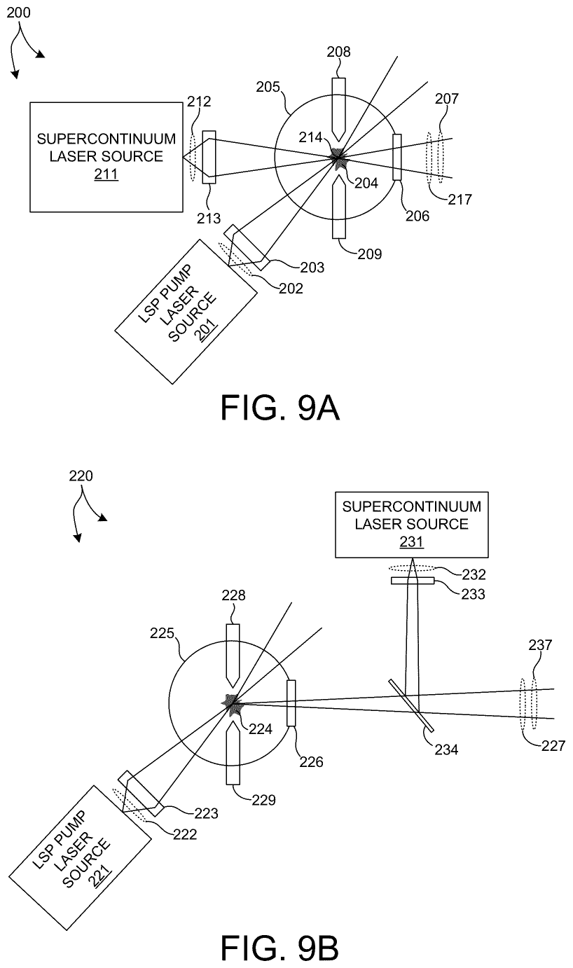

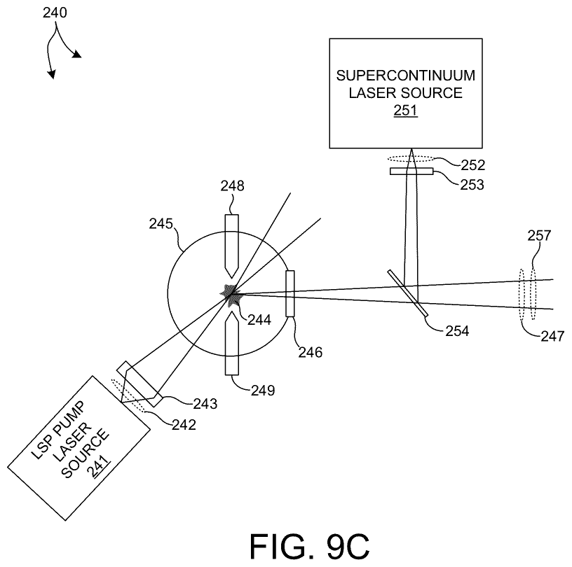

FIG. 9A depicts an embodiment 200 of a combined illumination source 110. As depicted in FIG. 9A, a voltage provided across a cathode 208 and an anode 209 generates a plasma 204 contained by bulb 205. In addition, a LSP pump laser source 201 generates pump light 202 that is focused by focusing optics 203 to sustain plasma 204 contained by bulb 205. Plasma 204 generates broadband spectrum light over a wavelength range of ultra-violet to short infrared. Ultraviolet/visible/short infrared light 207 generated by plasma 204 is provided to the illumination optics subsystem as described with reference to FIG. 1. In addition, supercontinuum laser source 211 generates infrared light 212. Infrared light 212 is focused by focusing lens 213 and forms a focus 214 at or near plasma 204. Infrared light 217 from focus 214 is provided to the illumination optics subsystem as described with reference to FIG. 1. In one example, UV/visible/short infrared light 207 and infrared light 217 are co-located and are effectively combined. In some examples, bulb 205 is constructed from Calcium Fluoride or Magnesium Fluoride to transmit wavelengths above 2.5 micrometers generated by supercontinuum laser source 211. In some other examples, bulb 205 includes one or more exit ports 206 fabricated from Calcium Fluoride or Magnesium Fluoride to transmit wavelengths above 2.5 micrometers generated by supercontinuum laser source 211. A conventional bulb constructed from fused silica does not transmit significant light above 2.5 micrometers, and is thus unsuitable for combining light generated by the supercontinuum laser illumination source 211 in the manner described herein.

FIG. 9B depicts an embodiment 220 of a combined illumination source 110. As depicted in FIG. 9B, a voltage provided across a cathode 228 and an anode 229 generates a plasma 224 contained by bulb 225. In addition, a LSP pump laser source 221 generates pump light 222 that is focused by focusing optics 223 to sustain plasma 224 contained by bulb 225. Plasma 224 generates broadband spectrum light over a wavelength range of ultra-violet to short infrared. Ultraviolet/visible/short infrared light 227 generated by plasma 224 exits bulb 225 through exit port 226 and is provided to the illumination optics subsystem as described with reference to FIG. 1. In addition, supercontinuum laser source 231 generates infrared light 232. Infrared light 232 is focused by focusing lens 233. Infrared light 237 from supercontinuum laser source 231 is provided to the illumination optics subsystem as described with reference to FIG. 1.

As depicted in FIG. 9B, UV/visible/short infrared light 227 and infrared light 237 are combined by beam combiner 234. As such, beam combiner 234 combines light generated by an ultraviolet light source 221 (e.g., LSP light source 221) with light generated by an infrared light source 231 (e.g., supercontinuum laser light source 231). In one example, the beam combiner 234 has a splitting wavelength, for example, at or near 900 nanometers. The beam combiner minimizes loss of light generated by the LSP light source (LSP loss less than 10%) and minimizes depolarization effects (e.g., less than 0.1%) across all illumination wavelengths.

FIG. 9C depicts an embodiment 240 of a combined illumination source 110. As depicted in FIG. 9C, a voltage provided across a cathode 248 and an anode 249 generates a plasma 244 contained by bulb 245. In addition, a LSP pump laser source 241 generates pump light 242 that is focused by focusing optics 243 to sustain plasma 244 contained by bulb 245. Plasma 244 generates broadband spectrum light over a wavelength range of ultra-violet to short infrared. Ultraviolet/visible/short infrared light 247 generated by plasma 244 exits bulb 245 through exit port 246 and is provided to the illumination optics subsystem as described with reference to FIG. 1. In addition, supercontinuum laser source 251 generates infrared light 252. Infrared light 252 is focused by focusing lens 253. Infrared light 257 from supercontinuum laser source 251 is provided to the illumination optics subsystem as described with reference to FIG. 1.

As depicted in FIG. 9C combined illumination source 110 provides ultraviolet and infrared illumination light to optically transparent substrate 120 selectively. In these examples, the measurement is time multiplexed. Mirror 254 is a moveable mirror. In one example, moveable mirror 254 is mounted to a galvanometer employed to selectively direct ultraviolet/visible light 247 and infrared light 257 to optically transparent substrate 120 based on whether moveable mirror 254 is locating in or out of the optical path of ultraviolet/visible light 247. In another example, a moveable total internal reflection prism is employed to selectively direct ultraviolet/visible light 247 and infrared light 257 to optically transparent substrate 120. In this manner, spectral measurements including ultraviolet/visible spectra are performed at a different time than spectral measurements including infrared spectra.

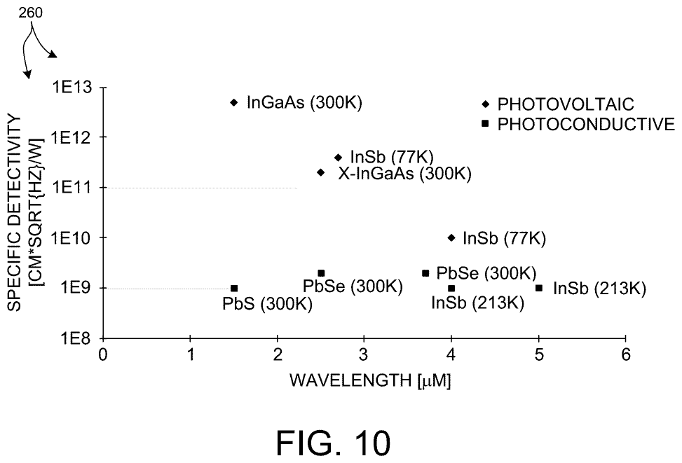

FIG. 10 depicts a plot 260 illustrative of the specific detectivity of various detector technologies operating at specified temperatures. As illustrated in FIG. 10, both photovoltaic and photoconductive detector technologies are suitable for detecting radiation at infrared wavelengths exceeding one micrometer, and up to five micrometers. In some examples, metrology system 100 include detectors such as lead sulfide (PbS), lead selenide (PbSe), indium antimonide (InSb), indium arsenide (InAs), mercury cadmium telluride (HgCdTe), indium gallium arsenide (InGaAs), x-InGaAs, pyroelectric, and bolometric detectors.

Pyroelectric and bolometric detectors are not quantum detectors. Thus, these detectors may accept high light levels without saturation, and thus reduce noise sensitivity.

In some embodiments, the detector subsystem is shot noise limited, rather than dark noise limited. In these examples, it is preferred to perform multiple measurements at high light levels to reduce measurement system noise.

In some embodiments, a time dependent measurement (e.g., pulsed light source, chopper, etc.) is performed in coordination with a lock-in amplifier or other phase locked loop to increase the measurement signal to noise ratio.

In some embodiments, one or more of the detectors are cooled to temperatures of −20° C., 210° K, 77° K, or other low temperature to reduce measurement noise. In general, any suitable cooling element may be employed to maintain the temperature of a detector at a constant temperature during operation. By way of non-limiting example, any of a multi stage Peltier cooler, rotating disc cooler, Stirling cycle cooler, N2 cooler, He cooler, etc. may be contemplated within the scope of this patent document.

In some embodiments, a broad range of wavelengths are detected by a detector that includes multiple photosensitive areas having different sensitivity characteristics. Collected light is linearly dispersed across the surface of the detector according to wavelength. Each different photosensitive area is arranged on the detector to sense a different range of incident wavelengths. In this manner, a broad range of wavelengths are detected with high signal to noise ratio by a single detector. These features, individually, or in combination, enable high throughput measurements of high aspect ratio structures (e.g., structures having depths of one micrometer or more) with high throughput, precision, and accuracy.

In some embodiments, a detector subsystem includes a multi-zone infrared detector that combines different sensitivity bands at different locations on a single detector package. The detector is configured to deliver a continuous spectrum of data at different sensitivities, depending on location of incidence.

FIG. 12 illustrates typical photosensitivity curves of available Indium Gallium Arsenide (InGaAs) sensors. As depicted in FIG. 12, no single sensor of the available InGaAs sensors is capable of providing adequate photosensitivity across a wavelength band from 1 micrometer to 2.5 micrometers. Thus, individually, the available sensors are only capable of sensing over a narrow waveband.

In some embodiments, multiple sensor chips, each sensitive in a different waveband are combined into a single detector package. In turn, this multi-zone detector is implemented in the metrology systems described herein.

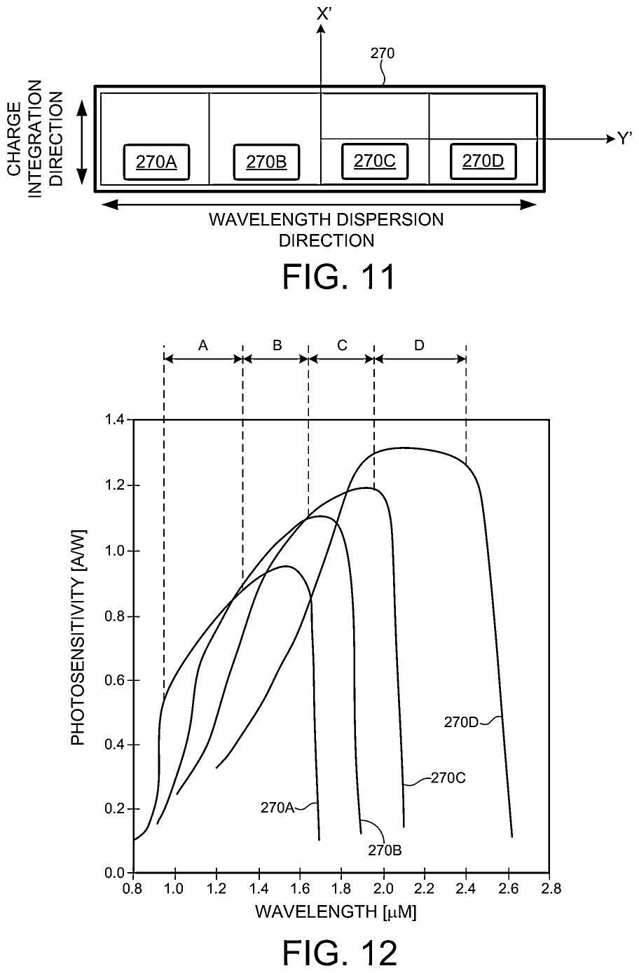

FIG. 11 depicts four sensor chips 270A-D derived from four different wavebands to make a multi-zone infrared detector 180. The four sensor chips include different material compositions that each exhibit different photosensitivity characteristics. As depicted in FIG. 11, sensor chip 270A exhibits high sensitivity over a waveband, A, sensor chip 270B exhibits high sensitivity over a waveband, B, sensor chip 270C exhibits high sensitivity over a waveband, C, and sensor chip 270D exhibits high sensitivity over a waveband, D. A metrology system incorporating detector 270 is configured to disperse wavelengths within waveband A onto sensor chip 270A, disperse wavelengths within waveband B onto sensor chip 270B, disperse wavelengths within waveband C onto sensor chip 270C, and disperse wavelengths within waveband D onto sensor chip 270D. In this manner, high photosensitivity (i.e., high SNR) is achieved over the aggregate waveband that includes wavebands A-D from a single detector. As a result measurement noise over the entire measurement range is reduced by limiting the use of a particular sensor to a narrowband where measurement sensitivity is high and measurement noise is low.

In some examples, a multi-zone detector includes InGaAs sensors with sensitivity to different spectral regions assembled in a single sensor package to produce a single, contiguous spectrum covering wavelengths from 750 nanometers to 3,000 nanometers, or beyond.

In general, any number of individual sensors may be assembled along the direction of wavelength dispersion of the multi-zone detector such that a contiguous spectrum maybe derived from the detector. However, typically, two to four individual sensors are employed in a multi-zone detector, such as detector 270.

In one embodiment, three individual sensors are employed with the first segment spanning the range between 800 nanometers and 1600 nanometers, the second segment spanning the range between 1600 nanometers and 2200 nanometers, and the third segment spanning the range between 2200 nanometers and 2600 nanometers.

Although, the use of InGaAs based infrared detectors is specifically described herein, in general, any suitable material that exhibits narrow sensitivity ranges and sharp sensitivity cutoffs may be integrated into a multi-zone detector as described herein.

As depicted in FIG. 1, the illustrated measurement channel includes a polarizer on the illumination side and an analyzer on the collection side. However, in general, it is contemplated that any measurement channel may include, or not include, an illumination polarizer, a collection analyzer, an illumination compensator, a collection compensator, in any combination, to perform measurements of the polarized reflectivity of the sample, unpolarized reflectivity of the sample, or both.

In some embodiments, one or more measurement channels of the metrology system are configured to measure the optically transparent substrate at different azimuth angles, in addition to different ranges of wavelength and angle of incidence. In some embodiments, a metrology system including an infrared spectrometer as described herein is configured to perform measurements of the optically transparent substrate at azimuth angles of zero and ninety degrees relative to the metrology target. In some embodiments, the metrology system is configured to measure optically transparent substrate reflectivity over one or more wavelength ranges, one or more AOI ranges, and one or more azimuth angles simultaneously. In some embodiments, a metrology system utilizes one or more combined LSP & supercontinuum sources in one or more spectroscopic ellipsometers, spectroscopic reflectometers, discrete wavelength ellipsometers, rotating polarizer ellipsometers, rotating compensator ellipsometers, rotating polarizer rotating compensator ellipsometers, Mueller-matrix ellipsometers, or any combination thereof.

In another further aspect, the dimensions of illumination field stop projected on optically transparent substrate plane are adjusted to optimize the resulting measurement accuracy and speed based on the nature of target under measurement.

In another further aspect, the dimensions of illumination field stop are adjusted to achieve the desired spectral resolution for each measurement application.

In some examples, e.g., if the sample is a very thick film or grating structure, the illumination field stop projected on optically transparent substrate plane in the direction perpendicular to the plane of incidence is adjusted to reduce the field size to achieve increase spectral resolution. In some examples, e.g., if the sample is a thin film, the illumination field stop projected on optically transparent substrate plane in the direction perpendicular to the plane of incidence is adjusted to increase the field size to achieve a shortened measurement time without losing spectral resolution.

In the embodiment depicted in FIG. 1, computing system 130 is configured to receive signals 154 indicative of the spectral response detected by the detector subsystem. Computing system 130 is further configured to determine control signals 119 that are communicated to programmable illumination field stop 117. Programmable illumination field stop 117 receives control signals 119 and adjusts the size of the illumination aperture to achieve the desired illumination field size.

In some examples, the illumination field stop is adjusted to optimize measurement accuracy and speed as described hereinbefore. In another example, the illumination field stop is adjusted to prevent image clipping by the spectrometer slit and corresponding degradation of measurement results. In this manner, the illumination field size is adjusted such that the image of the measurement target underfills the spectrometer slit. In one example, the illumination field stop is adjusted such that the projection of the polarizer slit of the illumination optics underfills the spectrometer slit of the metrology system. In another example, the illumination field stop is adjusted such that the projection of the polarizer slit of the illumination optics overfills the spectrometer slit of the metrology system.

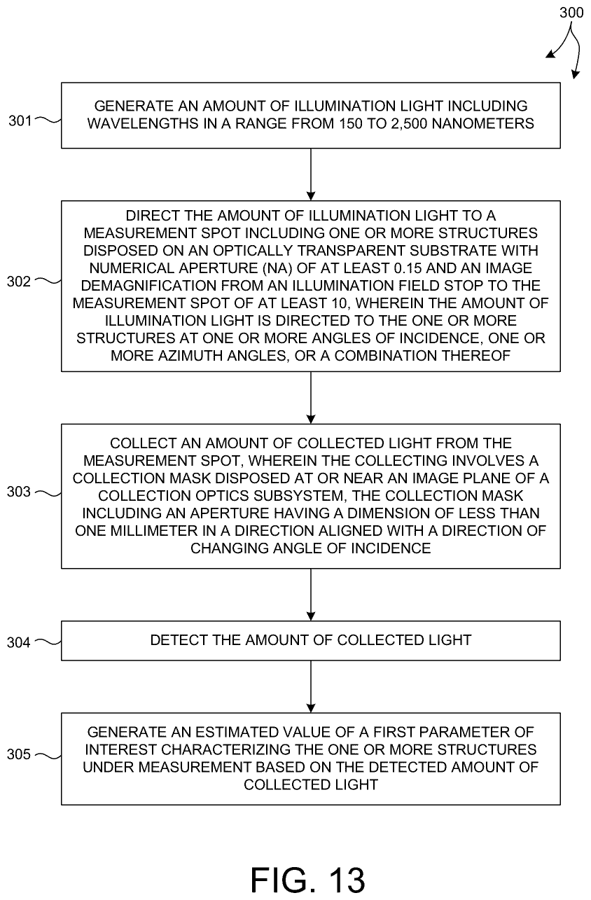

FIG. 13 illustrates a method 300 of performing spectroscopic measurements in at least one novel aspect. Method 300 is suitable for implementation by a metrology system such as metrology system 100 illustrated in FIG. 1 of the present invention. In one aspect, it is recognized that data processing blocks of method 300 may be carried out via a pre-programmed algorithm executed by one or more processors of computing system 130, or any other general purpose computing system. It is recognized herein that the particular structural aspects of metrology system 100 do not represent limitations and should be interpreted as illustrative only.

In block 301, an amount of illumination light is generated. The illumination light includes wavelengths in a range from 150 to 2,500 nanometers.

In block 302, the amount of illumination light from the illumination source is directed to a measurement spot including one or more structures disposed on an optically transparent substrate with Numerical Aperture (NA) of at least 0.15. The image demagnification from an illumination field stop to the measurement spot is at least 10, and the amount of illumination light is directed to the one or more structures at one or more angles of incidence, one or more azimuth angles, or a combination thereof.

In block 303, an amount of collected light is collected from the measurement spot. The collecting involves a collection mask disposed at or near an image plane of a collection optics subsystem. The collection mask includes an aperture having a dimension of less than one millimeter in a direction aligned with a direction of changing angle of incidence.

In block 304, the amount of collected light is detected at a detector.

In block 305, an estimated value of a first parameter of interest characterizing the one or more structures under measurement is generated based on the detected amount of collected light.

In a further embodiment, system 100 includes one or more computing systems 130 employed to perform measurements of actual device structures based on spectroscopic measurement data collected in accordance with the methods described herein. The one or more computing systems 130 may be communicatively coupled to the spectrometer. In one aspect, the one or more computing systems 130 are configured to receive measurement data associated with measurements of the structure of the specimen under measurement.

It should be recognized that one or more steps described throughout the present disclosure may be carried out by a single computer system 130 or, alternatively, a multiple computer system 130. Moreover, different subsystems of system 100 may include a computer system suitable for carrying out at least a portion of the steps described herein. Therefore, the aforementioned description should not be interpreted as a limitation on the present invention but merely an illustration.

In addition, the computer system 130 may be communicatively coupled to the spectrometers in any manner known in the art. For example, the one or more computing systems 130 may be coupled to computing systems associated with the spectrometers. In another example, the spectrometers may be controlled directly by a single computer system coupled to computer system 130.

The computer system 130 of metrology system 100 may be configured to receive and/or acquire data or information from the subsystems of the system (e.g., spectrometers and the like) by a transmission medium that may include wireline and/or wireless portions. In this manner, the transmission medium may serve as a data link between the computer system 130 and other subsystems of system 100.

Computer system 130 of metrology system 100 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board metrology system 100, external memory, or other external systems). For example, the computing system 130 may be configured to receive measurement data from a storage medium (i.e., memory 132 or an external memory) via a data link. For instance, spectral results obtained using the spectrometers described herein may be stored in a permanent or semi-permanent memory device (e.g., memory 132 or an external memory). In this regard, the spectral results may be imported from on-board memory or from an external memory system. Moreover, the computer system 130 may send data to other systems via a transmission medium. For instance, a measurement model or an estimated parameter value 171 determined by computer system 130 may be communicated and stored in an external memory. In this regard, measurement results may be exported to another system.

Computing system 130 may include, but is not limited to, a personal computer system, mainframe computer system, workstation, image computer, parallel processor, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

In some examples, the measurement models are implemented as an element of a SpectraShape® optical critical-dimension metrology system available from KLA-Tencor Corporation, Milpitas, California, USA. In this manner, the model is created and ready for use immediately after the spectra are collected by the system.

In some other examples, the measurement models are implemented off-line, for example, by a computing system implementing AcuShape© software available from KLA-Tencor Corporation, Milpitas, California, USA. The resulting, trained model may be incorporated as an element of an AcuShape® library that is accessible by a metrology system performing measurements.

In another aspect, the methods and systems for spectroscopic metrology of semiconductor devices described herein are applied to the measurement of high aspect ratio (HAR) structures, large lateral dimension structures, or both. The described embodiments enable optical critical dimension (CD), film, and composition metrology for semiconductor devices including three dimensional NAND structures, such as vertical-NAND (V-NAND) structures, dynamic random access memory structures (DRAM), etc., manufactured by various semiconductor manufacturers such as Samsung Inc. (South Korea), SK Hynix Inc. (South Korea), Toshiba Corporation (Japan), and Micron Technology, Inc. (United States), etc. These complex devices suffer from low light penetration into the structure(s) being measured. FIG. 3 depicts an exemplary high aspect ratio structure 160 that suffers from low light penetration into the structure(s) being measured. A spectroscopic ellipsometer with broadband capability and wide ranges of AOI, azimuth angle, or both, having simultaneous spectral band detection as described herein is suitable for measurements of these high-aspect ratio structures. HAR structures often include hard mask layers to facilitate etch processes for HARs. As described herein, the term “HAR structure” refers to any structure characterized by an aspect ratio that exceeds 2:1 or 10:1, and may be as high as 100:1, or higher.

In yet another aspect, the measurement results described herein can be used to provide active feedback to a process tool (e.g., lithography tool, etch tool, deposition tool, etc.). For example, values of measured parameters determined based on measurement methods described herein can be communicated to a lithography tool to adjust the lithography system to achieve a desired output. In a similar way etch parameters (e.g., etch time, diffusivity, etc.) or deposition parameters (e.g., time, concentration, etc.) may be included in a measurement model to provide active feedback to etch tools or deposition tools, respectively. In some example, corrections to process parameters determined based on measured device parameter values and a trained measurement model may be communicated to a lithography tool, etch tool, or deposition tool.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), and a displacement between two or more structures (e.g., overlay displacement between overlaying grating structures, etc.). Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect, including measurement applications such as critical dimension metrology, overlay metrology, focus/dosage metrology, and composition metrology. However, such terms of art do not limit the scope of the term “metrology system” as described herein. In addition, the metrology system 100 may be configured for measurement of patterned optically transparent substrates and/or unpatterned optically transparent substrates. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from the calibration of system parameters based on critical dimension data.

Various embodiments are described herein for a semiconductor measurement system that may be used for measuring a specimen within any semiconductor processing tool (e.g., an inspection system or a lithography system). The term “specimen” is used herein to refer to a optically transparent substrate, a reticle, or any other sample that may be processed (e.g., printed or inspected for defects) by means known in the art.

As used herein, the term “optically transparent substrate” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a optically transparent substrate may include only the substrate (i.e., bare optically transparent substrate). Alternatively, a optically transparent substrate may include one or more layers of different materials formed upon a substrate. One or more layers formed on a optically transparent substrate may be “patterned” or “unpatterned.” For example, a optically transparent substrate may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO2. A reticle may be disposed above a resist-covered optically transparent substrate during an exposure step of a lithography process such that the pattern on the reticle may be transferred to the resist.

One or more layers formed on a optically transparent substrate may be patterned or unpatterned. For example, a optically transparent substrate may include a plurality of dies, each having repeatable pattern features. Formation and processing of such layers of material may ultimately result in completed devices. Many different types of devices may be formed on a optically transparent substrate, and the term optically transparent substrate as used herein is intended to encompass a optically transparent substrate on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A spectroscopic metrology system comprising:
an illumination source configured to generate an amount of illumination light including wavelengths in a range from 150 to 2,500 nanometers;
an illumination optics subsystem configured to direct the amount of illumination light from the illumination source to one or more structures disposed on an optically transparent substrate at a measurement spot at one or more angles of incidence, one or more azimuth angles, or a combination thereof, the illumination optics subsystem having a Numerical Aperture (NA) of at least 0.15 and an image demagnification from an illumination field stop to the measurement spot of at least 10;
a collection optics subsystem configured to collect an amount of collected light from the measurement spot on the surface of the specimen, the collection optics subsystem including a collection mask disposed at or near an image plane of the collection optics subsystem, the collection mask including an aperture having a dimension of less than one millimeter in a direction aligned with a direction of changing angle of incidence;
at least one detector having a planar, two-dimensional surface sensitive to incident light, the at least one detector configured to detect the amount of collected light and generate output signals indicative of the detected light; and
a computing system configured to generate an estimated value of a first parameter of interest characterizing the one or more structures under measurement based on an analysis of the output signals.

2. The metrology system of claim 1, the collection optics subsystem configured to image the measurement spot onto the at least one detector with a field magnification of at least 10.

3. The metrology system of claim 1, wherein a collection Numerical Aperture (NA) of the collection optics subsystem is at least 0.15.

4. The metrology system of claim 1, wherein a dimension of the measurement spot along a direction of maximum extent is less than 50 micrometers.

5. The metrology system of claim 1, wherein the collection mask includes a plurality of apertures, each aperture configured to transmit the amount of collected light associated with a different range of angles of incidence from the specimen under measurement.

6. The metrology system of claim 1, wherein the illumination source is a combined illumination source including a laser sustained plasma (LSP) illumination source and a supercontinuum laser illumination source.

7. The metrology system of claim 1, wherein the at least one detector includes two or more detectors, wherein each of the two or more detectors detects a portion of the amount of collected light over different spectral ranges.

8. The metrology system of claim 7, wherein each of the two or more detectors detects each portion of the amount of collected light over different spectral ranges simultaneously.

9. The metrology system of claim 1, wherein the one or more structures under measurement include a grating structure.

10. The metrology system of claim 9, wherein the grating structure includes multiple grating vector orientations at the measurement spot.

11. The metrology system of claim 10, the computing system further configured to generate an estimated value of a second parameter of interest of the specimen under measurement based on an analysis of the output signals, wherein the amount of collected light includes light collected at a first azimuth angle and a second azimuth angle, the output signals are indicative of the detected light at the first and second azimuth angles, wherein the estimated value of the first parameter of interest is based on the output signals indicative of the detected light at the first azimuth angle, wherein the first parameter of interest characterizes the grating structure along a first grating vector orientation, wherein the estimated value of the second parameter of interest is based on the output signals indicative of the detected light at the second azimuth angle, and wherein the second parameter of interest characterizes the grating structure along a second grating vector orientation different from the first grating vector orientation.

12. The metrology system of claim 1, wherein the amount of collected light collected from the measurement spot on the surface of the specimen underfills the aperture of the collection mask.

13. The metrology system of claim 1, wherein the one or more structures under measurement comprise a metalens optical element.

14. The metrology system of claim 9, wherein the first parameter of interest is a critical dimension characterizing the grating structure disposed on the optically transparent substrate.

15. The metrology system of claim 1, wherein the first parameter of interest is a film thickness.

16. The metrology system of claim 1, wherein the one or more structures disposed on the optically transparent substrate comprise an augmented reality/virtual reality device.

17. A method comprising:
generating an amount of illumination light including wavelengths in a range from 150 to 2,500 nanometers;
directing the amount of illumination light to a measurement spot including one or more structures disposed on an optically transparent substrate with Numerical Aperture (NA) of at least 0.15 and an image demagnification from an illumination field stop to the measurement spot of at least 10, wherein the amount of illumination light is directed to the one or more structures at one or more angles of incidence, one or more azimuth angles, or a combination thereof;
collecting an amount of collected light from the measurement spot, wherein the collecting involves a collection mask disposed at or near an image plane of a collection optics subsystem, the collection mask including an aperture having a dimension of less than one millimeter in a direction aligned with a direction of changing angle of incidence;
detecting the amount of collected light; and
generating an estimated value of a first parameter of interest characterizing the one or more structures under measurement based on the detected amount of collected light.

18. The method of claim 17, further comprising:
imaging the measurement spot onto the at least one detector with a field magnification of at least 10.

19. The method of claim 17, wherein a collection Numerical Aperture (NA) of the collection optics subsystem is at least 0.15.

20. The method of claim 17, wherein the one or more structures under measurement comprise a metalens optical element or an augmented reality/virtual reality device.

21. The method of claim 1, wherein the first parameter of interest is a film thickness or a critical dimension, the critical dimension characterizing a grating structure disposed on the optically transparent substrate.

22. A spectroscopic metrology system comprising:
an illumination source configured to generate an amount of illumination light including wavelengths in a range from 150 to 2,500 nanometers;
an illumination optics subsystem configured to direct the amount of illumination light from the illumination source to one or more structures disposed on an optically transparent substrate at a measurement spot at one or more angles of incidence, one or more azimuth angles, or a combination thereof, the illumination optics subsystem having a Numerical Aperture (NA) of at least 0.15 and an image demagnification from an illumination field stop to the measurement spot of at least 10;
a collection optics subsystem configured to collect an amount of collected light from the measurement spot on the surface of the specimen, the collection optics subsystem including a collection mask disposed at or near an image plane of the collection optics subsystem, the collection mask including an aperture having a dimension of less than one millimeter in a direction aligned with a direction of changing angle of incidence;
at least one detector having a planar, two-dimensional surface sensitive to incident light, the at least one detector configured to detect the amount of collected light and generate output signals indicative of the detected light; and
a non-transitory, computer-readable medium storing instructions that, when executed by one or more processors, causes the one or more processors to:
generate an estimated value of a first parameter of interest characterizing the one or more structures under measurement based on an analysis of the output signals.
